(19) United States
(12) Patent Application Publication
(10) Pub. No.: US 2022/0376343 A1
(43) Pub. Date: Nov. 24, 2022

(54) MODULAR SYSTEM AND METHODS FOR HIGH-VOLTAGE BATTERY ARCHITECTURE

(71) Applicant: American Battery Solutions, Inc,, Lake Orion, MI (US)

(72) Inventors: Erik William Anderson, Troy, MI (US); Joshua William Payne, Oakland Township, MI (US); Jean-Paul Ortiz, White Lake, MI (US); Michael Paul Garascia, Waterford, MI (US); Matthew James Petraglia, Royal Oak, MI (US); Daniel-Dean Drake DeLorme, Lake Orion, MI (US); Marc Eduard Breitman, Clinton Township, MI (US); Matthew Jon Knoche, Clarkston, MI (US); Shad Alan Kelly, Warren, MI (US); Eric Walter Akkashian, Waterford, MI (US); Kriten Allison Swanson, Clarkson, MI (US); Nolan Joseph Salani, Oxford, MI (US); Elaine Elizabeth Parkansky, Troy, MI (US)

(21) Appl. No.: 17/744,589

(22) Filed: May 13, 2022

Related U.S. Application Data
(63) Continuation-in-part of application No. 17/319,170, filed on May 13, 2021.
Application No. 17/319,170 is a continuation-in-part of application No. PCT/US2022/013016, filed on Jan. 19, 2022.
Application No. PCT/US2022/013016 is a continuation-in-part of application No. 17/319,170, filed on May 13, 2021.
(60) Provisional application No. 63/268,954, filed on Mar. 7, 2022.

(51) Int. Cl. H01M 50/258; H01M 10/42; H01M 10/48; H01M 10/658; H01M 50/296

(52) U.S. Cl. CPC H01M 50/258; H01M 10/4257; H01M 10/482; H01M 10/486; H01M 10/658; H01M 50/296; H01M 2010/4278

(57) ABSTRACT

Systems and methods for a battery module including a subassembly that can include cells electrically connected to form a group; and groups of cells electrically connected to form the subassembly. The subassembly can include a lower cell carrier and an upper cell carrier configured to retain a thermally insulating material, the group of cells disposed between the upper and lower cell carriers, cell alignment and retention features integrally formed with one or more of: lower or upper cell carriers, means for inhibiting propagation of thermal runaway, a current collector comprising two or more conductive regions; and positive and negative terminals electrically connected to the two or more conductive regions, respectively, to form positive and negative terminals of battery module.

### CROSS REFERENCE TO RELATED APPLICATION

This application is a continuation in part of U.S. application Ser. No. 17/319,170, filed May 13, 2021, which is incorporated by reference in its entirety, as if fully set forth herein. This application claims priority to PCT Application No. PCT/US2022/013016, filed Jan. 19, 2022, which is a continuation in part of U.S. application Ser. No. 17/319,170, filed May 13, 2021, which are incorporated by reference in their entirety, as if fully set forth herein. This application also claims priority to U.S. Provisional Application No. 63/268,954, filed Mar. 7, 2022, which is incorporated by reference in its entirety, as if fully set forth herein.

### TECHNICAL FIELD

Embodiments of the present disclosure relate generally to a modular battery architecture, comprising modular components and sub-assemblies, and methods of manufacturing the same.

### BACKGROUND

Historically, internal combustion engines (ICE) have dominated applications for industrial, commercial, and fleet transportation. However, use of Original Equipment Manufacturer (“OEM”) Lithium-ion batteries for these applications is increasing, driven by advances in Lithium-ion battery technology, including advances in battery performance and cost. Today, OEM batteries are used in, for example, light-duty trucks, medium-duty trucks, heavy-duty trucks, buses, delivery vehicles, mining equipment, construction equipment, and marine vehicles. Conventional batteries can assume multiple, different form factors and chemistries including, without limitation, lead-acid, nickel metal hydride (“NiMH”), and lithium-ion (LFP, NMC, etc.), some of which may be incompatible with product requirements or impose substantial product development costs to accommodate or correct these incompatibilities. As a result, OEMs often develop custom solutions for these applications, but would prefer readily configurable, high-volume, “off the shelf” battery solutions to meet their desired cost, performance, and production goals. To address these diverse applications and architectures, the present disclosure provides a modular architecture which can be readily configured and scaled to meet varying requirements of multiple application.

Since current battery solutions provide a diverse selection of sizes and shapes of batteries, as well as techniques and parts for connecting multiple batteries, in order to achieve higher effective voltage and/or capacity. They typically require multiple battery assemblies, connectors, connections, and other components, resulting in an increased bill of materials. Prior approaches modularize batteries in small units, which require multiple external connectors and connections, resulting in increased battery footprint, increased electrical resistance, and decreased battery durability. Applications in which multiple batteries are connected through external connections result in diminished energy density and high maintenance costs due to the increased size, volume, and weight of the battery assemblies. Maintenance requirements can be substantial because many parts and connections may be exposed to environmental insult and degradation, reducing cycle life of the connections and of the battery. Further, exposure of external connections limits use in marine applications.

Conventional industrial batteries are typically configured for different voltage ratings, from 350 to 800V, with 350V, 400V, 660V, as typical configurations. This range of configurations requires different batteries having different voltages, which are not met by conventional designs. Similarly, Conventional industrial batteries are typically configured for different energies, from 25 kWh to 600 kWh, with 50 kWh, or 100 kWh as typical configurations. This range of configurations similarly requires different batteries having different energies, which not met by conventional designs.

There is a need for an improved battery that is robust, with high specific energy, high energy density, scalability and configurability, and lowers the total cost of ownership.

Additionally, there is a need for an improved battery that can be configured by modifying only a limited number of parts, is adaptable to differing capacity requirements, while retaining the balance of the remaining bill of materials.

There is also a need for improvements over current lithium-ion batteries by adapting battery pack sizes to the spaces typically allocated by vehicle manufacturers for energy storage systems in motive power applications. In order to enhance adoption of electrification, batteries should fit in commonly available spaces in motive applications, such as in the chassis frame. Chassis frame widths vary depending on the vehicle application and typically provide 600-1000 mm, requiring battery packs that fit in this width. Chassis frame heights vary depending on the vehicle application, typical battery pack height vary from 150-350 mm. Chassis frame lengths vary depending on the vehicle application, typical battery packs vary in length from 1000-3000 mm, providing a further battery pack requirement.

The improved battery of the present disclosure can meet these varying requirements. Batteries of the present disclosure can include a case-mounted battery management system (“BMS”), further decreasing the number of components and attachments, shrinking the form factor relative to conventional form factors, and making the battery more resistant to water or dust intrusion. See, e.g., ISO Standard IP65 and/or IP67. In contrast, prior known batteries typically use a separate BMS enclosure, attached to the battery or the application housing, as well as separate electrical and communication wired between the battery and the BMS.

Assembling conventional batteries typically involve substantial bills of materials, and numerous assembly and attachment steps. The use of multiple fasteners, connectors, fillers, and structural components results in multiple parts that may be susceptible to fatigue, loosening, damage, or failure during usage.

There is a need for an improved method of assembling batteries that reduces the bill of materials and assembly steps.

Disclosed embodiments may include an unconventional battery subassembly, modular architecture, improved components, and improved assembly methods. Relative to prior known solutions, embodiments of the present disclosure can provide an improved battery, compatible with multiple commercially acceptable form factors. This can provide certain benefits, including one or more of the following: a higher specific energy, higher energy density, improved abuse tolerance, robustness to environmental shock and intrusion, reduced cost of ownership, and fully integrated within a single assembly. Other embodiments may include methods of assembling batteries to produce one or more of compatible form factors, more concise designs, better integrated structures, reduced bill of materials, integrated battery management systems, ISO Standard IP65 and/or IP67-compliant products, increased reliability, and increased flexibility in manufacturing and use.

### SUMMARY

Embodiments of the present disclosure include a modular architecture that provides improved energy density and flexibility. Flexibility can be provided in three ways. First, embodiments of the present disclosure feature a high degree of commonality of component parts, namely, some or all the same components can be used in different form factors to make a variety of batteries that differ in voltage and/or capacity. Second, multiple modules can be added in order to increase pack and system voltage within the main enclosure. Third, multiple batteries can be combined (electrically connected in parallel) to build capacity to meet energy requirements of the application. Embodiments of the present disclosure can achieve greater flexibility by changing none, one, two, or only a few, component parts. For example, the voltage or energy of the battery can be changed without changing any component part, by increasing or reducing the number of cells in the battery. The disclosed architecture provides substantial flexibility to a manufacturer and/or user.

In embodiments of the present disclosure, cells can be connected in subassemblies, and subassemblies electrically connect in the desired configuration to meet desired capacity and/or voltage requirements. In embodiments of the present disclosure, flexibility can mean having an entirely or substantially common bill of materials, with changes to the number of cells, current collector design, and/or BMS.

This present disclosure enables cost-effective production of lithium-ion batteries with any desired form factor, at different system level voltages and capacities. This is achieved by sharing most or all internal parts between the different battery voltages to reduce fasteners and manufacturing cost. Adding a dispensed material to inhibit thermal propagation, such as a foam, enables closer packing of cells and enhances mechanically securing cells without fasteners and/or other additional structural components.

In the present disclosure, cells can be connected in parallel to build capacity at the voltage of an individual cells; or in series to build voltage at the capacity of the individual cells. Cells can electrically connect in series to form a group (e.g., S-Group) and groups of cells electrically connected in parallel to form a subassembly. Alternatively, in one embodiment, cells are electrically connected in parallel to form a (e.g., P-Group) and groups of cells electrically connected in series to form a subassembly. In an embodiment, two subassemblies are electrically connected using a configurable current collector to accommodate the form factor of the system. The first subassembly comprises a lower cell carrier and upper cell carrier between which the first groups of cells are disposed. The second subassembly comprises the lower cell carrier and upper cell carrier between which a second group of cells are disposed. The current collector comprises two or more conductive regions. The first and second subassemblies can be connected in parallel or series to build the desired voltage or capacity of the battery. Positive and negative terminals can connect to first and second conductive regions, respectively, to form positive and negative terminals of the battery.

The present disclosure achieves higher energy density through one or more of multiple features. The lower and upper cell carriers are configured to affix the cells in position, resist displacement, and dispose the cells in close proximity to one another. Encasing the cells in a dispensed material in the gaps between cells enhances safety by inhibiting propagation of thermal runaway and robustness to vibration, shock, mechanical displacement, and environmental insult. This combination of features enables embodiments of the present disclosure to achieve higher energy density. Further, integration of the positive and negative terminals into the BMS and current collector, and press fitting of components reduces the number of electrical connections required and facilitates efficient manufacturing and effective electrical connection.

A battery module can include a subassembly which can include cells electrically connected to form a group, and groups of cells electrically connected to form the subassembly. The subassembly can include a lower cell carrier and an upper cell carrier configured to retain a thermally insulating material. The group of cells can be disposed between the upper and lower cell carriers. Cell alignment and retention features can be integrally formed with one or both of: lower or upper cell carriers. Additionally, battery module can include a means for inhibiting propagation of thermal runaway, a current collector comprising two or more conductive regions, and positive and negative terminals electrically connected to the two or more conductive regions, respectively to form positive and negative terminals of battery module.

As described herein, “means for inhibiting thermal runaway” is simply and interchangeably described as an inhibitor. In some embodiments, the inhibitor mitigates or entirely avoids propagation of thermal runaway. Non-limiting examples of such inhibitors include one or more of: a dispensed material, cold plate, a barrier, coatings, membranes, or combinations or one or more of them.

In some embodiments, means for inhibiting propagation of thermal runaway can include preventing propagation of thermal runaway from a first cell of the group of cells to a second cell in the same group of cells in the same module.

In some embodiments, means for inhibiting propagation of thermal runaway can include preventing propagation of thermal runaway from a first cell in the group of cells to a second cell in an adjacent module.

In some embodiments, the group of cells can be a first group of cells, the subassembly can be a first subassembly, the current collector can be a first current collector, and the battery module can include: a second subassembly including a second group of cells electrically connected to form a second subassembly. The second subassembly can include a lower cell carrier and an upper cell carrier between which the second group of cells can be disposed, and having first and second faces, and a second current collector electrically connecting the second subassembly.

Some embodiments can include adding capacity by increasing the number of cells in the subassembly.

Some embodiments can include reducing capacity by decreasing the number of cells in the subassembly.

Some embodiments can include first current collector, and module comprising second current collector, wherein the module can include the second current collector has a voltage different from the module comprising the first current collector.

In some embodiments, first current collector and module can include second current collector configured to use the same components other than the current collector.

In some embodiments can include, first current collector, and module comprising second current collector, wherein the module can include the second current collector has capacity different from the module comprising the first current collector.

Some embodiments can include first current collector, and module including second current collector configured to use the same components other than the current collector.

Some embodiments can include first current collector, and module comprising second current collector, wherein the module comprising the second current collector has a different voltage and the same energy as the module comprising the first current collector.

Some embodiments can include first current collector, and module comprising second current collector configured to use the same components other than the current collector.

Some embodiments can include first current collector, and module of claim 1 comprising second current collector, wherein the module comprising the second current collector has a different capacity and the same energy as the module comprising the first current collector.

Some embodiments can include first current collector, and module comprising second current collector configured to use the same components other than the current collector.

In some embodiments, current collector further comprises one or more layers, layers can include: a conductive layer comprising a pattern defining a plurality of conductive regions; and isolation layer.

In some embodiments, current collector can include one or more layers, layers can include a pressure sensitive adhesive layer, conductive layer comprising pattern defining a plurality of conductive regions, and isolation layer.

Some embodiments can include telemetry module in communication with one or more sensors associated with subassembly, the one or more sensors configured to detect at least one of: a temperature or a voltage.

Some embodiments can include battery comprising one or more battery modules, the quantity of modules determined by desired voltage or amp-hour requirements, enclosure comprising case and a lid, extruded aluminum profile forming case, and forming one or more enclosures from extruded aluminum profile.

In some embodiments, two or more extruded aluminum enclosures vary in depth.

In some embodiments, two or more extruded aluminum enclosures vary in length.

In some embodiments, battery can include lid includes stiffening pattern formed integrally thereon.

In some embodiments, battery can include battery management system (BMS) including electrical components associated with BMS functionality, BMS configured to communicate with one or more telemetry modules associated with one or more battery modules.

In some embodiments, increasing number of electrical components can be associated with additional BMS functionality.

In some embodiments, decreasing number of electrical components can be associated with limited BMS functionality.

In some embodiments, BMS functionality can include at least one of: fast charging, remote pre-charging, or auxiliary input.

### BRIEF DESCRIPTION OF THE DRAWINGS

The accompanying drawings, which are incorporated in and constitute a part of this specification, illustrate several embodiments and, together with the description, explain the disclosed principles. In the drawings:

FIGS. 1A and 1B are exploded schematic views of a battery pack, according to an embodiment of the present disclosure.

FIGS. 2A and 2B are an exploded schematic view of a battery module, according to an embodiment of the present disclosure.

FIG. 3A is an exploded schematic view of a heat sink, according to an embodiment of the present disclosure.

FIG. 3B is a cross-section views of a heat sink, according to an embodiment of the present disclosure.

FIG. 3C is a heat map depicting steady-state simulated performance of a heat sink of the present disclosure under-estimated maximum steady-state thermal load, including temperature data from a computer simulation, according to an embodiment of the present disclosure.

FIG. 4 is an exploded schematic view of a partially assembled subassembly, according to an embodiment of the present disclosure.

FIG. 5A is an exploded schematic view of a subassembly with cross-section insets illustrating a multifunctional cell tray and gasket, according to an embodiment of the present disclosure.

FIG. 5B is a detail schematic view of a lower cell carrier, according to an embodiment of the present disclosure.

FIG. 6A is a detail schematic view of an upper cell carrier, according to an embodiment of the present disclosure.

FIG. 6B is a detail schematic view of an electrically connected subassembly, according to an embodiment of the present disclosure.

FIGS. 6C and 6D depict cross-sections of example current collectors, according to embodiments of the present disclosure.

FIGS. 6E-H are schematic views of current collectors having different cell groups, according to embodiments of the present disclosure.

FIG. 7 is a detail schematic of a cell venting barrier, according to an embodiment of the present disclosure.

FIG. 8A is a block diagram illustrating networking of a battery management system (BMS), according to an embodiment of the present disclosure.

FIG. 8B is a schematic block diagram of a BMS and BDU, according to an embodiment of the present disclosure.

FIG. 8C is a schematic block diagram of a telemetry module, according to an embodiment of the present disclosure.

FIG. 9 is flowchart for a method for assembling a battery, according to an embodiment of the present disclosure.

FIGS. 10A to 10C are isometric schematic views of modules, according to embodiments of the present disclosure.

FIGS. 11A to 11D are isometric exploded schematic views of a battery packs without assemblies, according to embodiments of the present disclosure.

FIGS. 12A to 12D are isometric exploded schematic views of battery packs, according to embodiments of the present disclosure.

FIG. 13A is a fully populated BDU, according to an embodiment of the present disclosure.

FIGS. 13B to 13D are example depopulated BMS configurations, according to embodiments of the present disclosure.

### DESCRIPTION OF THE EMBODIMENTS

Embodiments consistent with the present disclosure can include a battery pack, modular components thereof, and an improved method of assembly. Cells are preferably connected in parallel to form a group of cells (e.g., P-Group). Groups of cells are preferably connected in series to form a subassembly. A subassembly can comprise one-half of a battery module's cells. Cells can be cylindrical, prismatic, or pouch types. Two or more subassemblies can connect to a cold plate in embodiments of the present disclosure to form a battery modules. A battery pack can include multiple battery modules assembled in a housing to protect the cells from external shock, vibration, and environmental insult. A battery pack can provide nominal voltage of 350 V, 400 V, 660 V, 700 V, 800 V, or any other suitable voltage according to device or product application. Additionally, or alternatively, a battery pack can be configured to provide a non-standard nominal voltage, according to specific device or product specification. A battery pack can provide a nominal energy of 50 kWh, 94 kWh, 100 kWh, 110 kWh, 150 kWh or any other suitable energy according to device or product application. Additionally, or alternatively, a battery pack can be configured to provide a non-standard nominal energy, according to specific device or product specifications. Preferred embodiments can be configured to 350V-50 kWh, 400V-94 kWh, 350V-100 kWh, and 660V-110 kWh classes.

Embodiments of the present disclosure provide an improved modular architecture, provide greater manufacturing flexibility, and better scalability and configurability, relative to prior known batteries.

Embodiments of the present disclosure feature a high degree of commonality of component parts. Namely, some or all the same components can be used in the same or different form factors to make a variety of batteries that differ in voltage and/or capacity, by changing only a few or preferably no component parts. For example, voltage and capacity can be changed by increasing or reducing the number of cells in a battery. This improved modular architecture provides substantial flexibility to a manufacturer or user.

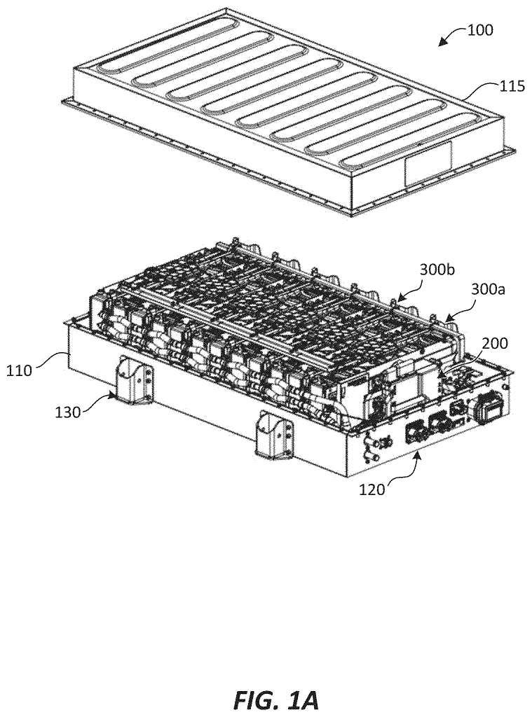

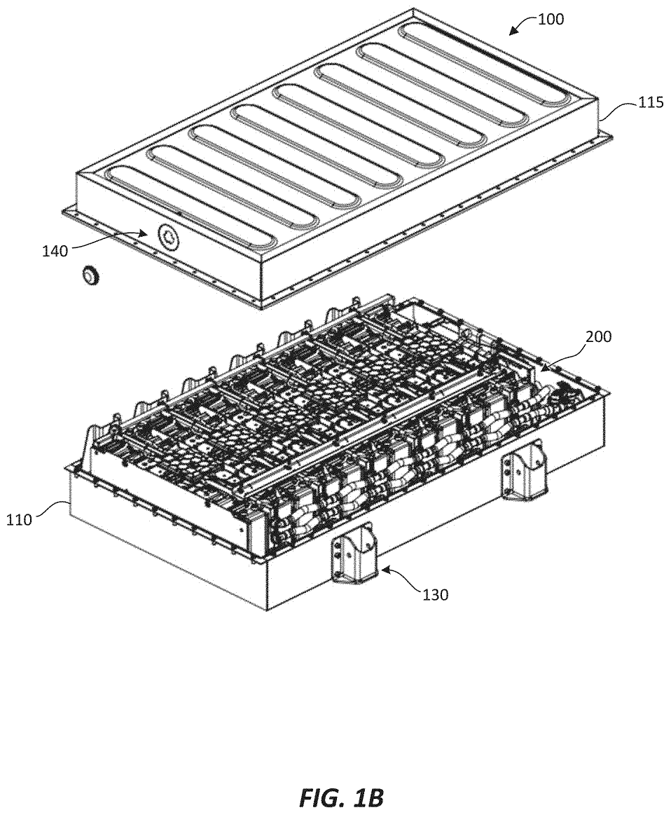

FIGS. 1A and 1B depict battery 100 (e.g., battery pack), which can include case 110, lid 115, electrical interface 120, mounting system 130, vent 140, battery management system (BMS) 200, and assembly 300a (e.g., battery module). When reference is made to at least case 110 and lid 115, it can be referred to as an enclosure. Additionally or alternatively, battery 100 can include multiple assemblies, for example assemblies 300a, 300b. Assembly 300b is substantially similar to assembly 300a, as such, it will be understood that assembly 300b includes elements and/or features substantially similar to those elements and/or features described with reference to assembly 300a. Descriptions will not be repeated for elements and/or features substantially similar to those elements and/or features described with reference to assembly 300a.

In some examples, case 110 can be dimensioned to receive assembly 300a and/or to standard or pre-determined dimensions. Case 110 can comprise one or more of: electrically insulating material, thermally insulating material, and/or fire-retardant material. In another example, case 110 can be flat, patterned, textured, coated, or ribbed. Case 110 can receive lid 115, thereby creating an operational seal between lid 115 and case 110. A sealing element such as a gasket can be inserted between lid 115 and case 110, or pre-applied to lid 115 or case 110, to create an operational seal between lid 115 and case 110. In a preferred embodiment, seal can comprise compressible gasket.

Additionally, or alternatively, CAN bus interface of BMS 200 can be used, BMS 200 can send and/or receive data using one or more processors to communicate with one or more batteries connected to CAN bus interface. Data may include self-identifying information (e.g., model, serial number, error codes), information indicating battery status, and/or information indicating battery configurations (e.g., series configuration and/or parallel configurations). In some examples, indicator wiring harness can be in electrical communication with BMS 200 and indicator, configured to transport data and/or electrical signals between one another.

In some examples, case 110 can be manufactured from extruded aluminum members where each member can be cut to desired dimensions and assembled for an intended battery pack configuration, thereby reducing the number unique parts required to manufacture different battery pack configurations. Extruded aluminum members can be engineered such that structural integrity and engineering requirements are satisfied across different battery pack configurations of case 110.

In some examples, lid 115 can include one or more of: electrically insulating material, thermally insulating material, and/or fire-retardant material. In another example, lid 115 can be flat, patterned, textured, coated, or ribbed. In some examples, lid 115 can be manufactured from single plate, which can be cut to desired dimensions and assembled for an intended battery pack configuration. This construction can enable reducing the number unique parts required to manufacture different battery pack configurations. Lid 115 can include a stiffening pattern, which can be common across different plate dimensions. Pattern can be engineered such that structural integrity and engineering requirements are satisfied across different plate dimensions of lid 115.

Electrical interface 120 can be a receptacle to facilitate data communications between BMS 200 and external computing devices, such as, computers, mobile devices, or battery chargers, battery charging stations, on-boards computers of various vehicles, or other battery management systems. Electrical interface wiring harness can be in electrical communication with BMS 200 and electrical interface 120 configured to transport data and/or electrical signals between one another.

Vent 140 can include a membrane configured to rupture at a desired pressure gradient between the internal pressure of the assembled enclosure and the external ambient pressure of the assembled enclosure.

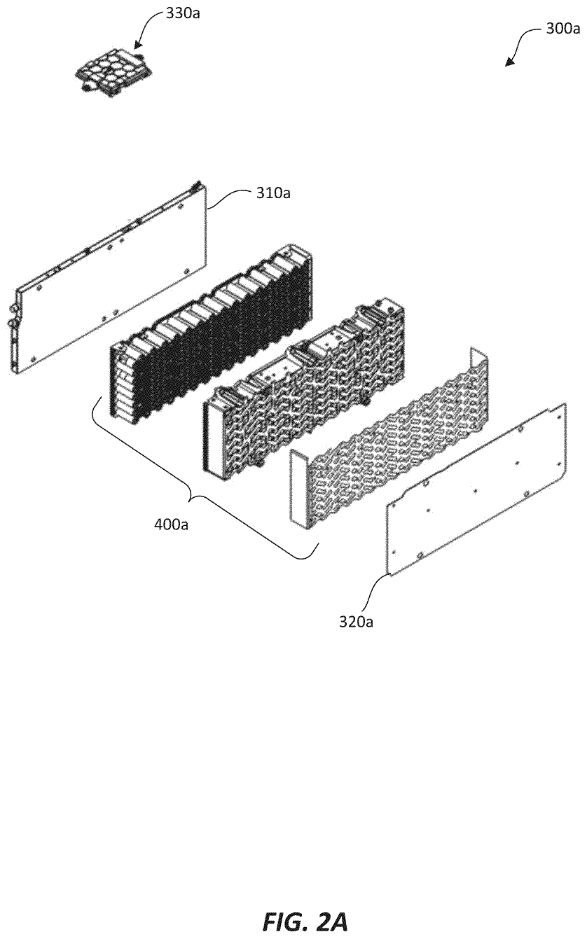

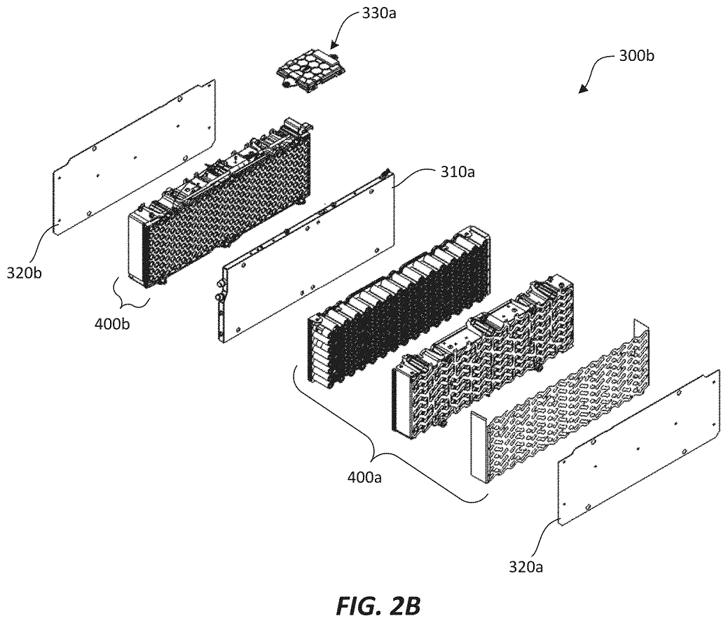

FIGS. 2A and 2B are exploded-view schematics of assemblies. FIG. 2A depicts assembly 300a including heat sink (e.g., cold plate) 310a, cell venting barrier 320a, telemetry module 330a, and first subassembly 400a (e.g., subassembly). FIG. 2B depicts another embodiment including second cell venting barrier 320b and second subassembly 400b. In some examples, air gap can be disposed between two subassemblies 400a and 400b, instead of heat sink 310a, providing electrical and/or thermal isolation between subassemblies 400a and 400b. In some examples, heat transfer material can be disposed in air gap to facilitate heat transfer while maintaining electrical isolation. In some examples, heat sink 310a can be disposed between subassemblies 400a, 400b. Heat sink 310a can be passively or actively cooled, for example, water-cooled or air-cooled. Additionally, or alternatively, heat sink 310a can be passively cooled such that heat sink 310a can be configured to release heat substantially by natural convection.

In some embodiments, thermal interface material can be disposed between subassembly 400a and heat sink 310a to transfer heat away from subassembly 400a. In some examples, heat sink 310a can be electrically isolated from negative terminals of cells. Means for inhibiting propagation of thermal runaway can include coatings, foam, films, cold plate, membranes, barriers, and/or mica sheets.

Subassembly 400b is substantially similar to subassembly 400a. Persons of ordinary skill in the art be understood that subassembly 400b includes elements and/or features substantially similar to those elements and/or features described with reference to subassembly 400a. Descriptions will not be repeated for elements and/or features substantially similar to those elements and/or features described with reference to subassembly 400a.

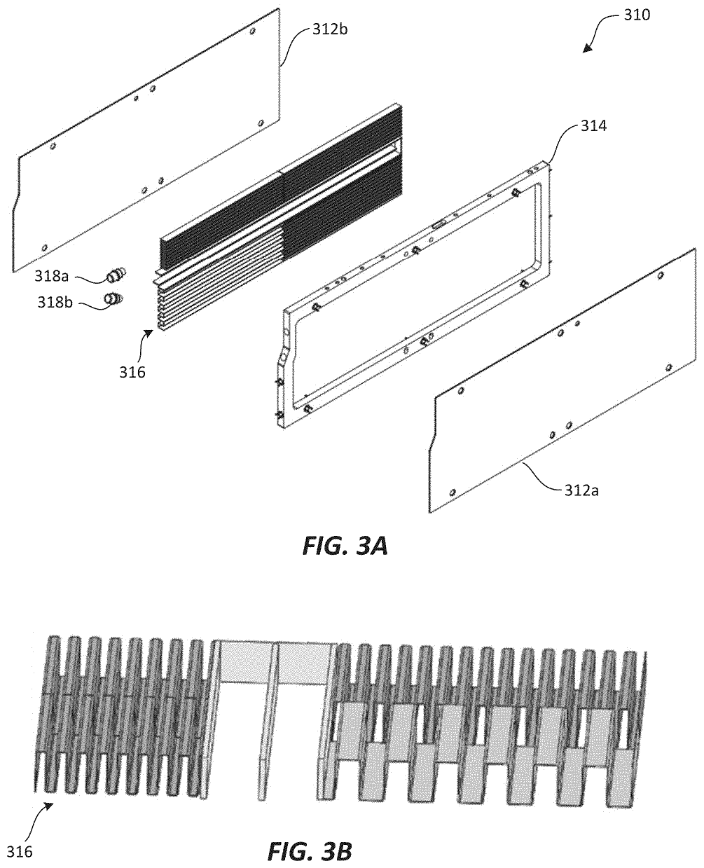

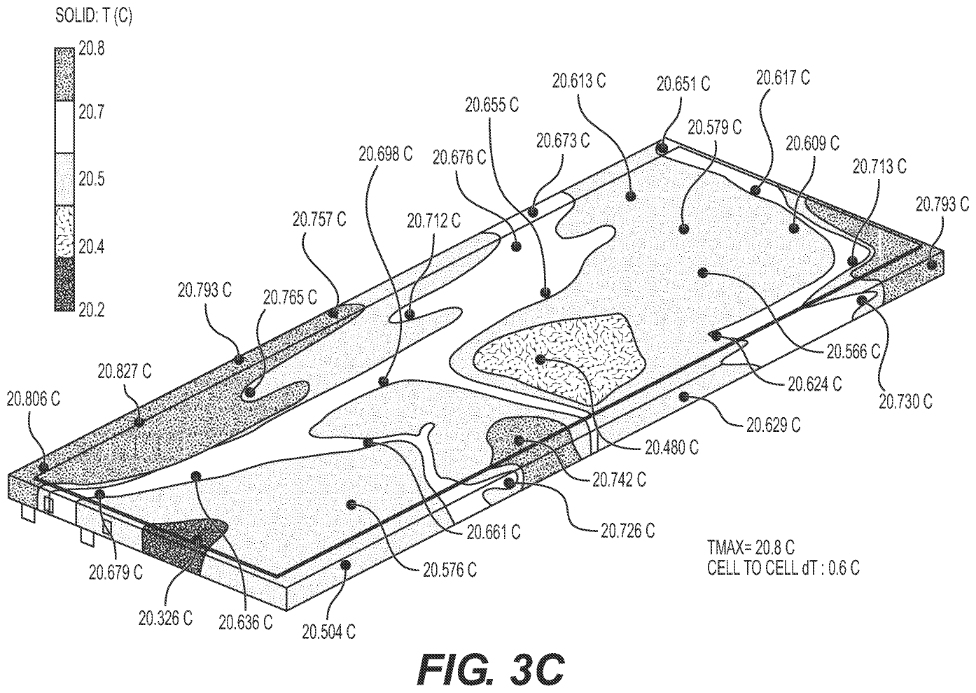

FIG. 3A is an oblique exploded schematic view of heat sink. Heat sink 310a can include first and second plates 312a, 312b, frame 314, channels 316, outlet 318a, and inlet 318b. In some examples, heat sink 310a can be, in part or entirely, constructed from at least one of: copper, aluminum, carbon nanotubes, carbon composites, or other suitable materials. Frame 314 can include, at least in part, at least one of: low density plastics, lightweight metal, or other suitable low-density materials. Additionally, or alternatively, frame 314 can include high thermal conductivity materials, for example, carbon composites, aluminum and/or copper. In some examples, fluid, such as glycol-water mixture, can circulate through channels 316. Fluid can enter channels 316 through inlet 318b and exit through outlet 318a. Fluid can come in contact with plates 312a, 312b, facilitating heat transferred with plates 312a, 312b from subassembly 400a to subsequently transfer to the fluid, thereby cooling subassembly 400a.

FIG. 3B illustrates example channel 316 configuration and fluid flow pattern consistent with channel 316 configuration. Channels 316 can be tuned to balance performance and cost considerations for a given application without adversely impacting the interfaces of the heat sink to subassemblies 400a and 400b.

FIG. 3C depicts steady-state surface temperatures for heat sink 310a, according to simulation results. An estimated 0.6° C. temperature difference was achieved by utilizing a high-mass flow rate through heat sink 310a. Other embodiments may tolerate larger surface temperature gradients, in which case the geometry of channel 316 may be simplified to reduce cost.

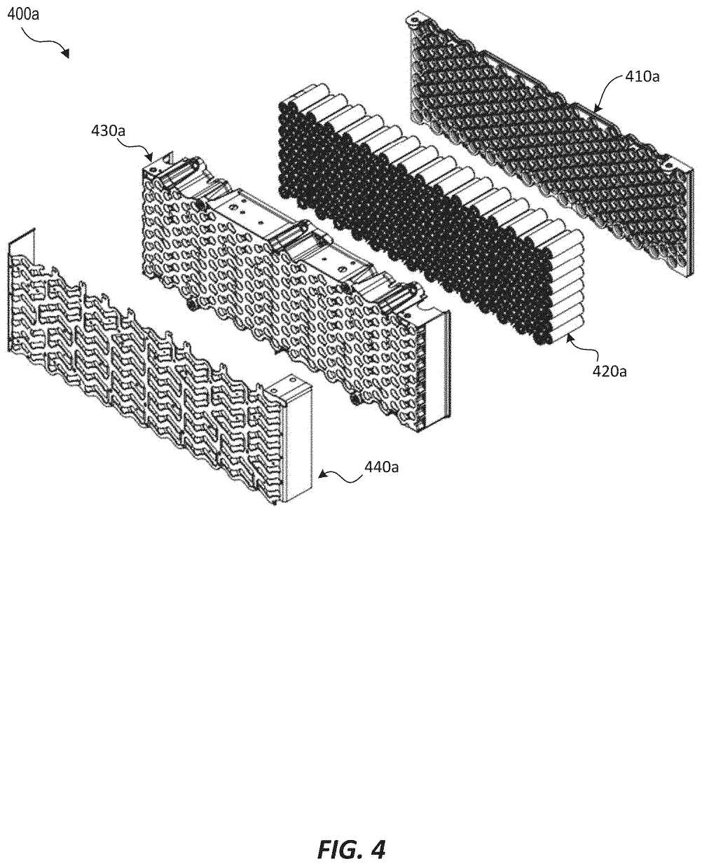

FIG. 4 depicts an exploded schematic view of a partially-assembled subassembly. Subassembly 400a can include inner cell carrier (e.g., bottom cell carrier or lower cell carrier) 410a, group of cells 420a, outer cell carrier (e.g., top cell carrier or upper cell carrier) 430a, and current collector 440a. Additional embodiments can be created by changing the number of cells in group 420a within the assembly, as lower cell carrier 410a, upper cell carrier 430a, and current collector 440a adjust in size according to the number of cells in group 420a. Similarly, other embodiments that include a lower number of cells in group 420a can be created without changing the design of lower cell carrier 410a, upper cell carrier 430a, and current collector 440a, by depopulating cell locations within the existing components. This may be done to reduce investment in new embodiments of lower cell carrier 410a, upper cell carrier 430a and current collector 440a at a tradeoff of energy density.

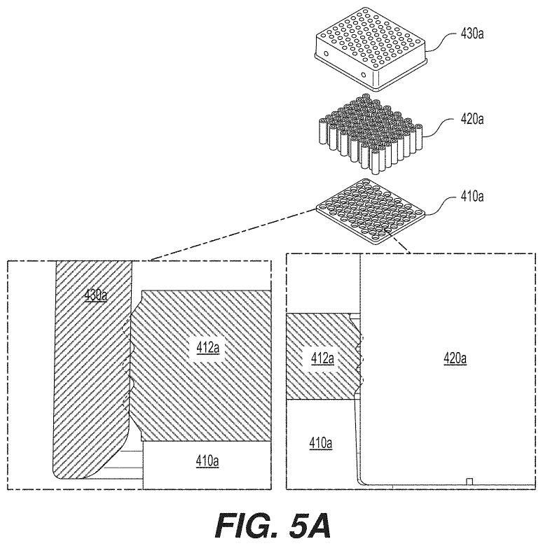

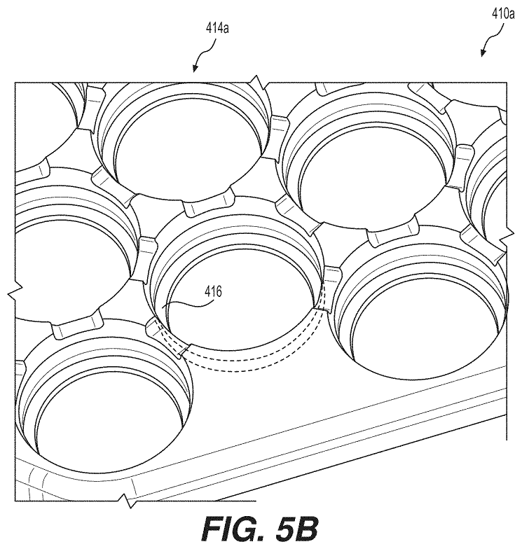

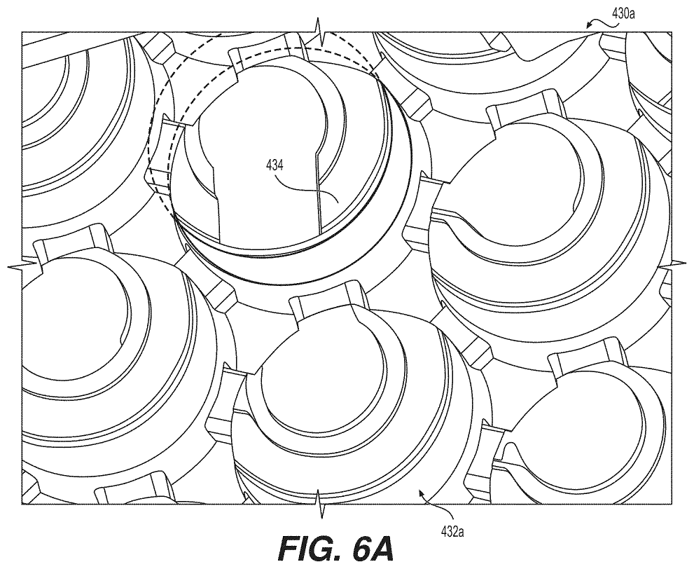

FIG. 5A illustrates an exploded schematic view of a subassembly with a schematic inset illustrating a gasket. Gasket 412a can be integrally formed onto inner cell carrier 410a. Alternatively, gasket 412a can be placed into inner cell carrier 410a. Gasket 412a can be configured to form interference fit against outer cell carrier 430a when outer cell carrier 430a is placed atop inner cell carrier 410a, thereby creating an effective seal between inner and outer cell carriers 410a and 430a. Additionally or alternatively, gasket 412a can be configured to form interference fit against group of cells 420a, thereby creating an effective seal between inner cell carrier 410a and group of cells 420a. Alternatively, inner cell carrier 410a may be made of the same material as gasket 412a, reducing total part count in subassembly 400a. Alternatively, seal may comprise compressible gasket material.

As discussed below, seal can aid in inhibiting or preventing dispensed material from seeping out of subassembly 400a during the injection process of materials. Dispensed material can inhibit thermal propagation and/or provide vibration dampening between cells.

For example, dispensed material can affix cells in a configuration or orientation. This can improve the reliability of the battery when the battery is subject to vibrations or impact by minimizing relative motion between cell and fusible link. Minimizing the relative motion avoids a break in the connection between the cell and the fusible link. Additionally, affixing cells can improve manufacturing yields by reducing the frequency of false-positive defects reported during the tensile check of the wire bonding process.

In some embodiments, dispensed material can provide vibration resilience by reducing the energy transmitted to cells from an impact or vibration imparted on battery. The resilience minimizes relative motion between cell and fusible link. Minimizing the relative motion avoids a break in the connection between the cell and the fusible link. The resilience can also inhibit puncture or mechanical failure of cell as a result of vibration or impact acting as a physical barrier between cells and external object.

In some embodiments, dispensed material can also provide thermal protection by inhibiting or preventing of thermal runaway propagation. Dispensed material can have low thermal conductivity, thereby thermally isolating a cell experiencing thermal runaway (e.g., venting). By thermally isolating the venting cell, the high temperature associated with a venting cell is not fully imparted onto adjacent cell, thereby keeping adjacent cell under a critical temperature and inhibiting or preventing thermal runaway propagation.

In some embodiments, dispensed material can form a viable gas release path to vent 140. Dispensed material can be permeable to gases expelled by venting cell. In some embodiments, dispensed material can form permeable path away from venting cell. In some embodiments, dispensed material can form permeable path toward vent 140.

In some embodiments, dispensed material can be selected to be compatible with effective solvent associated with disassembly of the battery at end of life. Effective solvent can be a solvent aids in the disassembly and/or recycling of battery 100.

Additionally, due to dispensed material being contained within the subassembly 400a, fixtures and processes related to curing the dispensed material are not necessary. Each cell in group of cells 420a can comprise positive terminal and negative terminal. In some examples, negative terminal can comprise substantially or all of outer surface, apart from a small portion isolated electrically from the positive terminal to provide negative terminal electrical contact.

FIG. 5B is a detail schematic view of lower cell carrier. Inner cell carrier 410a can include plurality of apertures 414a. Inner cell carrier 410a can include one or more of: electrically insulating material, thermally insulating material, or fire-retardant material. In some examples, each of the plurality of apertures 414a of inner cell carrier 410a can include tapering sidewall 416. Tapering sidewall 416 can be integral to inner cell carrier 410a and can form an interference fit upon receiving cell of group of cells 420a, thereby creating a seal against inner cell carrier 410a. As discussed below, this seal aids in the prevention of dispensed material from seeping out of subassembly 400a during the injection process.

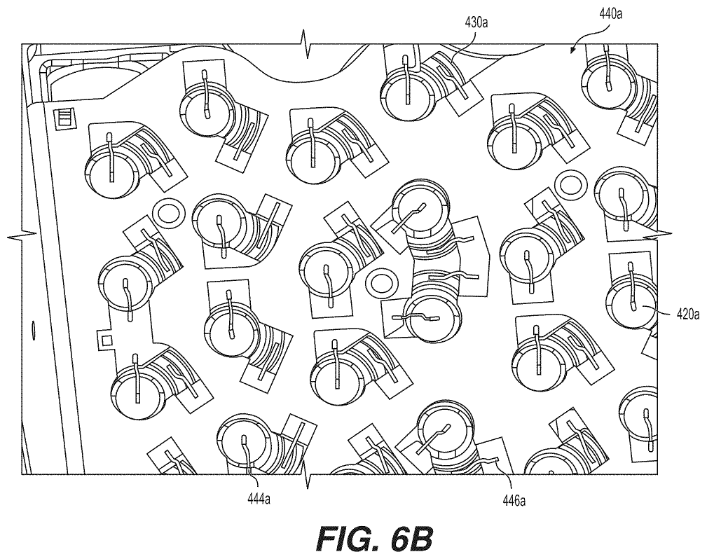

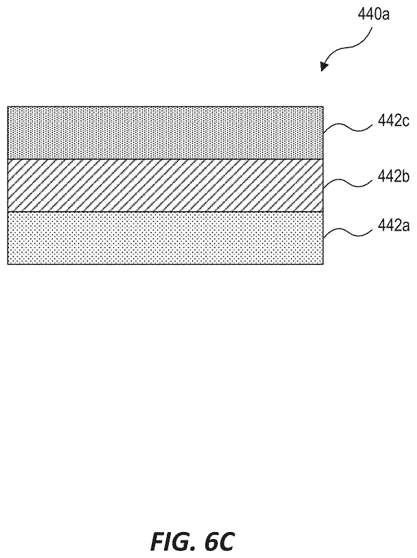

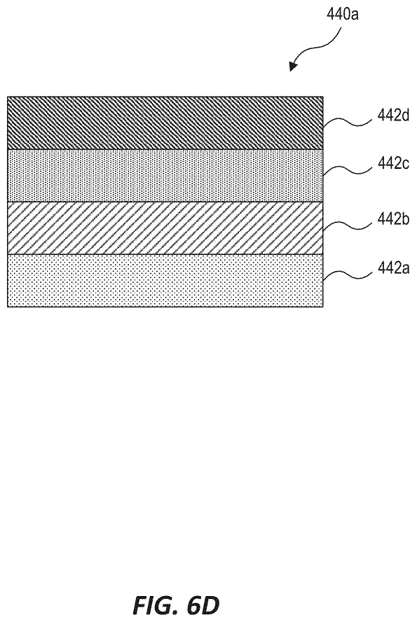

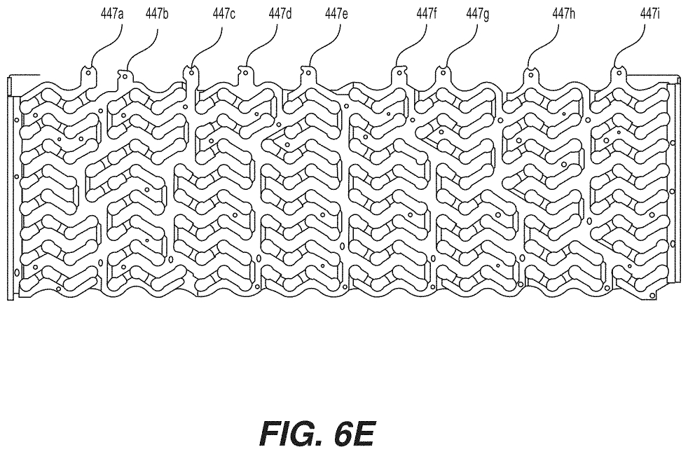

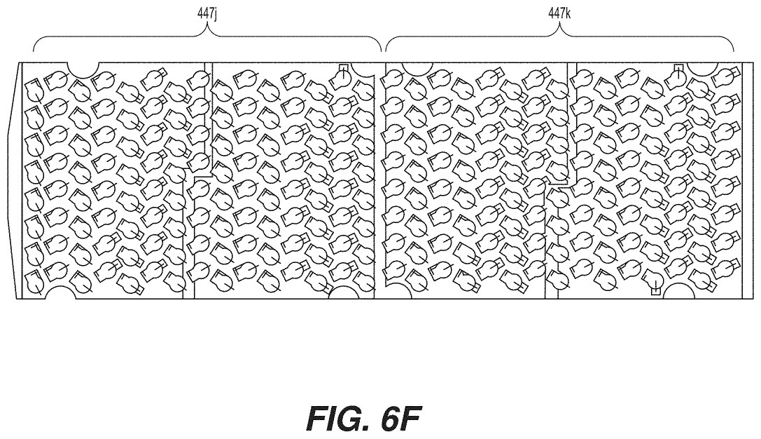

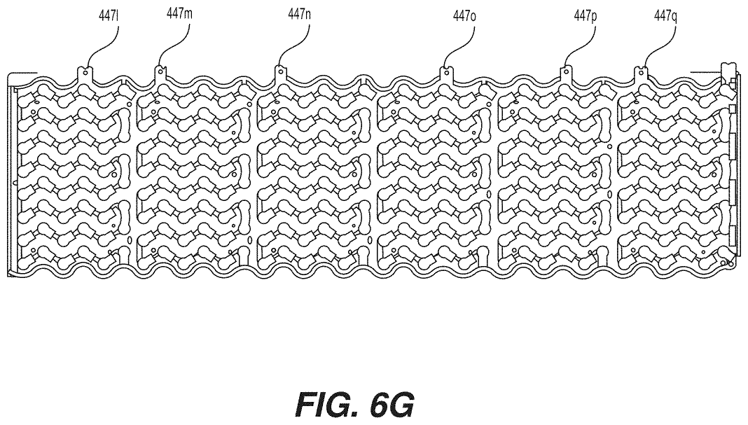

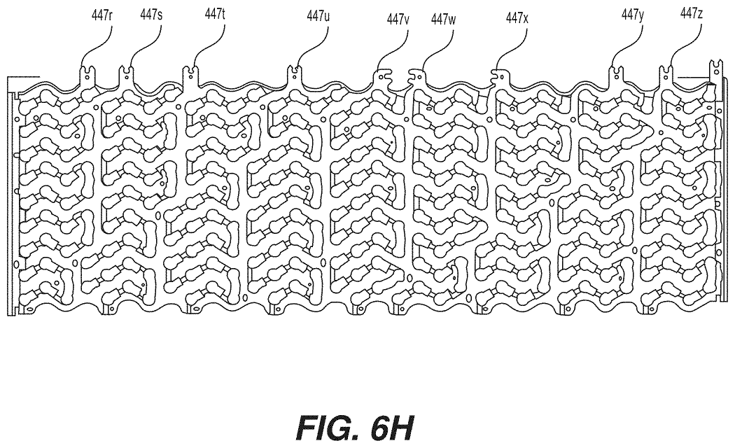

FIG. 6A is a detail schematic view of upper cell carrier. Outer cell carrier 430a can include plurality of apertures 432a including semi-circular lip with tapering sidewall 434. Cell carrier can provide enhanced flexibility in assembling batteries of varying voltage, current, and energy from common components. Cutout in outer cell carrier 430a provides flexibility in disposing a current collector 440a to facilitate different architectures based on common components, while modifying only the pattern of conductors in current collector. Outer cell carrier 430a can include one or more of: electrically insulating material, thermally insulating material, or fire-retardant material. The semi-circular lip with tapering sidewall 434 can be integral to outer cell carrier 430a and can form an interference fit upon receiving cell of group of cells 420a, thereby creating a seal against outer cell carrier 430a. As discussed below, this aids in the prevention of dispensed material seeping out of subassembly 400a during injection.

FIG. 6B depicts a detail schematic view of an electrically connected subassembly. Current collector 440a can include a plurality of conductive regions. Current collector 440a can be configured so that cells are connected in series and/or parallel. FIG. 6E, depict a plurality of conductive regions 447a-447i. Each conductive region can include integrated fuses, thereby removing the need for fuses within wiring harnesses found in conventional batteries. FIGS. 6F to 6H illustrate example embodiments where the number and pattern of conductive regions, as illustrated by conductive regions 447j-447z, can be configured to meet voltage or capacity requirements.

In some examples, current collector 440a can include layered, current collector 440a. Layers within current collector 440a can provide voltage sensing, fusible elements, fiducial points, and conduct electricity. For example, one layer can be a copper conductive layer while other layers are non-conductive. This can allow each cell to connect to the conductive layer in series and/or parallel groupings.

In examples, current collector 440a can be flexible or bendable (e.g., foldable) without breaking or sustaining damage. Current collector 440a can reduce the number of joints within module, leading to lower resistance and greater ease of manufacturing. Current collector 440a can be bendable around center point, line, or other axis, comparable to a hinge. Current collector 440a can include no, one, or more bends.

In examples, current collector 440a can include stamped or printed fusible links. Current collector 440a can comprise different suitable materials and coatings. Current collector 440a can mechanically and electrically connect to battery cells to form subgroups of battery cells connected in series and/or parallel. Subgroups of cells can be connected by current collector 440a in series and/or parallel with other subgroups of cells.

In examples, current collector 440a can connect to cells by wire bonding, laser welding, adhesive, or other appropriate electrically conductive connection.

Fusible links 444a and/or 446a can carry current from cells to current collector 440a. Fusible links 444a, can serve as a fuse to sever the connection between an individual cell and current collector at an appropriate current flow level. This may enhance safety by preventing combustion or a thermal event. Specifically, fusible link may melt and disconnect cell from current collector and, thus, remaining cells. This design can be tailored for the desired voltage and/or current. The precise parameters of fusible link 444a can be controlled by varying the shape, thickness, width, and/or material composition of fusible link 444a.

Fusible link 444a can be integrally formed within current collector. Structure of fusible link 444a may be varied to meet a variety of functional, performance, or safety requirements according to individual product design and use.

Fusible link 444a can comprise wire bond, laser welded connection, or ribbon bonds to join current collector to cells as fuse. Multiple alternative shapes and fusible link designs may perform the same function. Persons of skill in the art would understand that the shape and size of fusible link may depend on individual specifications, such as variances among cells, fusing characteristics, materials, cell types, process of manufacture, and intended use. In certain embodiments, fusible link can be a laser-welded, stamped fusible link.

Fusible links can increase overall safety of battery. Fusible links can provide fuse functionality to the current collector, without the need for specialized processes or additional parts, which may introduce the potential for substantial variances and errors. Fusible links can connect to terminals of battery cells using either resistance or laser welding, wire bonding, adhesive, or other electrically conductive connection.

FIGS. 6C and 6D depict current collector 440a, which can comprise one or more layers 442a, 442b, and/or 442c. In an example, current collector 440a can include first layer 442a, which can include pressure sensitive adhesive or heat activated adhesive configured to bond to subassembly 400a. Second layer 442b can include conductor, for example, copper or aluminum. Second layer 442b can include aluminum, copper, or other conductive metal and can be configured to receive one or more wire bond(s) or other suitable connections from one or more of: group of cells 420a. Third layer 442c can comprise a plastic layer for example, PET.

In some embodiments, current collector 440a can be designed to carry a 350A current, 450A current, or greater current for 60 seconds. In some embodiments, current collector 440a can be designed to carry 100A current, 180A current, 250A current, or greater current continuous current. The copper or aluminum thickness to carry these current loads is preferably 0.2 to 0.8 mm thick. Holes can be added at bending corners to assist with bending and buckling of current collector. Wire bonds or other electrical connections are preferably not placed near the fold. The negative cut-out in conductor is preferably disposed to align with separation between conductors to preserve conductive material.

In an alternative embodiment, as shown in FIG. 6D, current collector 440a need not include first layer 442a and can attach using mechanical fasteners, adhesive, heat stakes, retention posts, UV-cure epoxy, insert molded methods to subassembly 400a. Additionally, current collector 440a offers substantial flexibility, and can be adapted to carry current in multiple alternative configurations. Preferably, sufficient current collector cross-section is maintained to not add heat or impair current transport.

In alternative embodiments of the present disclosure adapted for higher voltage applications, fourth layer 442d can be added and include further conductive layer and can be deposited on third layer 442c. Fourth layer can comprise aluminum, copper, or other conductive metal and can be configured to receive one or more wire bond(s) or other suitable connections from one or more of: group of cells 420a. Fourth layer 442d can include plurality of conductive regions, for example, plurality of conductive regions.

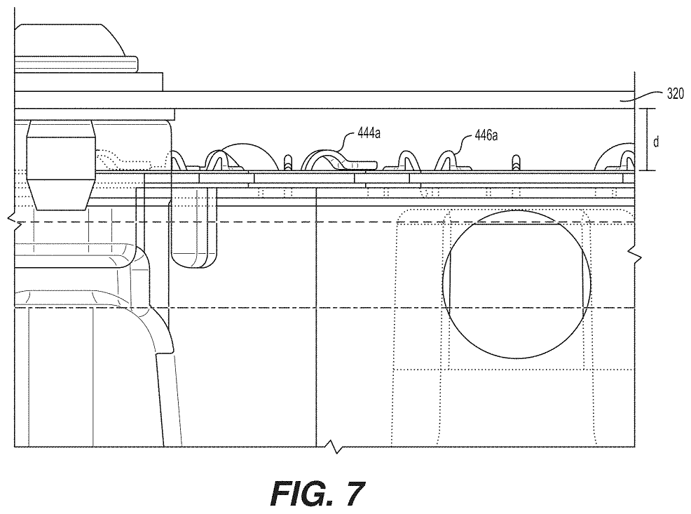

FIG. 7 illustrates a profile-view schematic of cell venting barrier 320a fastened to subassembly 400a. Cell venting barrier 320a can be an explosion-resistant thermal insulator. Cell venting barrier 320a can be configured to withstand a cell venting event, thereby protecting casing 110 and/or other components from thermal or physical damage due to cell venting. Cell venting barrier 320a can attach to subassembly 400a having clearance distance d between cell venting barrier 320a and current collector 440a. The clearance distance, d, can be a range of distances from 7 mm to 10 mm This cell venting barrier 320a can protect both the cells included in subassembly 400a as well as cells from adjacent cell module assemblies 300a in the battery pack. In some embodiments, cell venting barrier 320a can be attached to the case 110 or lid 115.

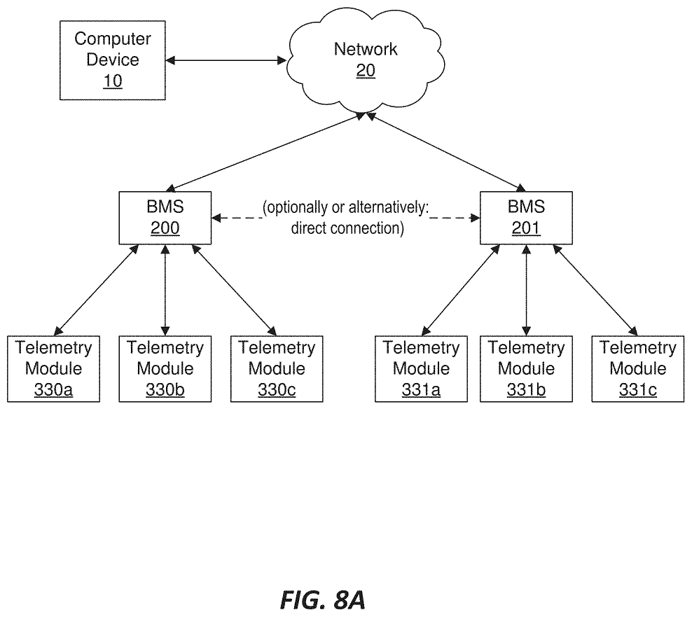

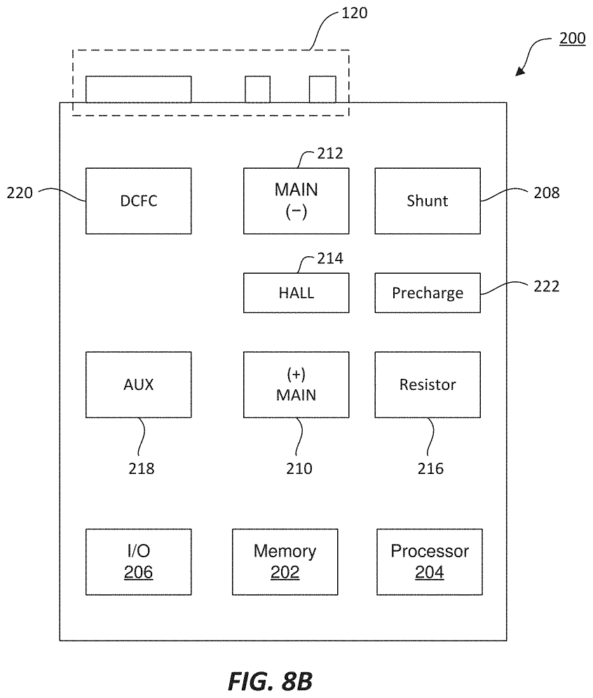

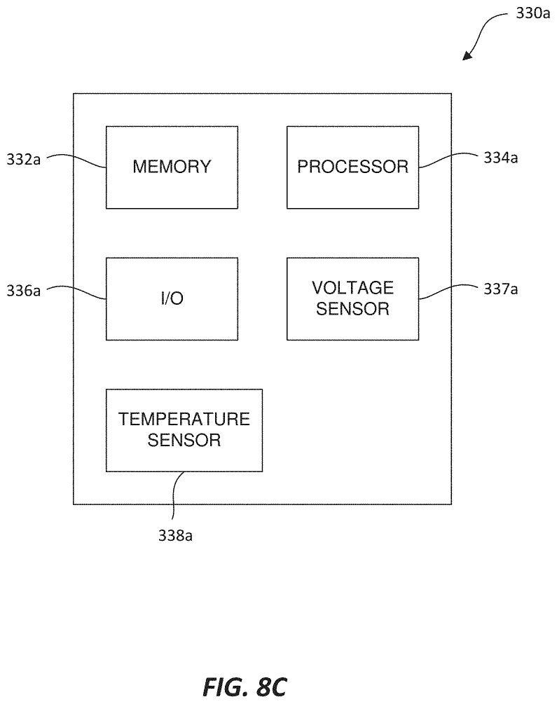

FIG. 8A is a block diagram illustrating networking of battery management system (BMS). In some examples, battery management system (BMS) 200, can be networked, allowing coordination and communication between multiple batteries or battery modules though data communications. In some examples, BMS 200 can provide wired or wireless communication with one or more telemetry modules 330a, 330b, 330c, and configured to receive at least one of: current data, temperature data, and/or voltage data of a cell or group of cells (e.g., group of cells 420a) associated with one or more telemetry modules 330a, 330b, 330c. BMS 200 can be configured to analyze and/or report data received from one or more telemetry modules 330a, 330b, 330c.

FIG. 8B is a schematic block diagram of BMS 200. BMS 200 can include one or more processors 204, memory 202 with instructions thereon, which, when executed, can cause BMS 200 to perform one or more functions. The one or more function can include managing electrical and/or thermal loads, detecting errors, or sending and/or receiving data to/from external computing devices. Additionally, BMS 200 can include I/O interface 206, configured to communicate between BMS and electrical interface 120. Additionally, or alternatively, I/O module 206 can include wired or wireless networking capability, for example, ethernet, WiFi, Bluetooth, NFC, cell phone bands/antennas, GPS, or any other suitable communication technology. BMS 200 can include shunt 208, positive terminal 210, and negative terminal 212. Additionally, BMS 200 can include at least one of: hall effect sensor 214, resistor 216, AUX interface 218, DC fast charging module 220, or precharge 222. Some embodiments can include Hall sensor and shunt sensor as redundancies contributing to ASIL rating of current measurement functions. Some embodiments can include AUX to allow the vehicle integrator to power other high-voltage devices at lower currents (e.g., 10A-40A) from battery voltage, thereby reducing components which increase vehicle cost and complexity. Some embodiments can include a DC fast charge output, which is a direct connection to the vehicle's charging port, thereby reducing components which increase vehicle cost and complexity.

FIG. 8C is a schematic block diagram of telemetry module. Telemetry module 330a can include one or more processors 334a, memory 332a with instructions thereon, which, when executed, can cause telemetry module 330a to perform one or more functions. The one or more functions can include managing electrical and/or thermal loads, detecting errors, or sending and/or receiving data to/from external computing devices. Additionally, telemetry module 330a can include I/O interface 336a. I/O module 206 can include wired or wireless networking capability, for example, ethernet, WiFi, Bluetooth, NFC, cell phone bands/antennas, GPS, or other communication technologies. In an example, telemetry module 330a can communicate with BMS 200, and transmit data to BMS 200 for analysis and/or reporting. Additionally, telemetry module 330a can include at least one of: voltage sensor 337a or temperature sensor 338a associated with at least a cell of a group of cells. Temperature and voltage sensors 338a, 337a, can be utilized to monitor and transmit cell group electrical load data to BMS 200.

In some examples, BMS 200 can communicate over wired or wireless network 20 with computing device 10, such as a tablet, smartphone, laptop, desktop, vehicle head unit, or vehicle energy management systems. Alternatively, BMS 200 can be in direct communication with computing device 10 though Bluetooth, NFC, ethernet, USB, or other communication interfaces.

In an example, computing device 10 can program or re-program BMS 200.

In some examples, BMS 200 can transmit battery status information, battery performance information, and/or battery maintenance information to computing device 10.

In some examples, BMS 200 can be in wired or wireless communication over network 20 with BMS 201. Alternatively, BMS 200 can be in direct communication with BMS 201 though Bluetooth, NFC, ethernet, USB, or other communication interfaces.

BMS 201 may be substantially similar to BMS 200, and telemetry modules 330b-330c, 331a-331c may be substantially similar to telemetry module 330a.

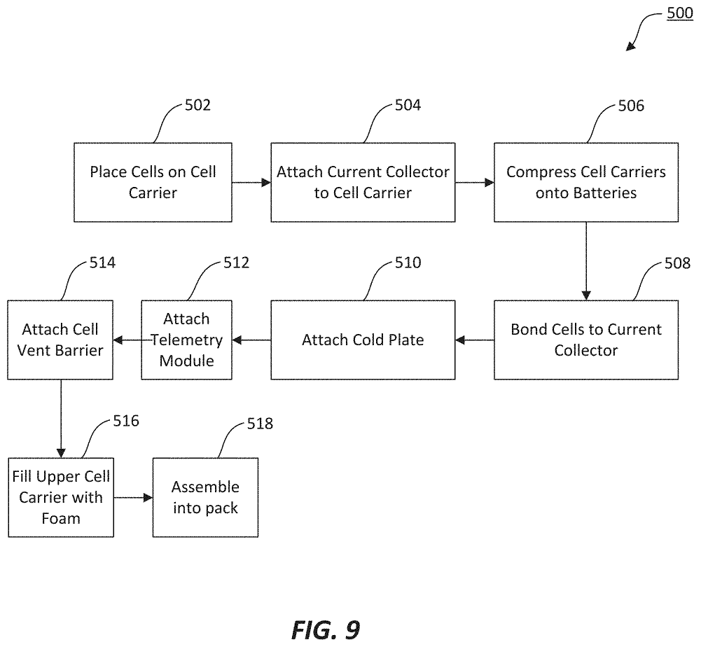

FIG. 9 depicts a method of manufacturing battery 100. The basic steps of an exemplary method are depicted in FIG. 9. Steps comprising method can be varied, combined, omitted, reordered, or otherwise altered according to the target specifications of the battery, consistent with the scope of this disclosure.

At block 502, method 500 can include placing cells on lower cell carrier and recording relevant cell traceability data tied to the specific cell and location within the carrier. Inner and outer cell carriers are preferably adapted to accept cells by interference fit, either with or without an insert to facilitate fitting cells into cell carriers. In embodiments, insert can be placed into recess of inner cell carrier, thereby electrically isolating each cell from cold plate, while disposing the cell in sufficient proximity to cold plate to facilitate effective heat transfer. Alternatively, in a preferred embodiment, the part can be provided by a manufacturer with the threaded inserts installed. Additionally, or alternatively, thermistors and/or voltage sensors can be installed proximate one or more cells.

At block 504, method 500 can include attaching current collector to upper cell carrier. Current collector can be attached using one or more of: adhesives, plastic rivets, screws, clips, or other attachment mechanisms.

At block 506, method 500 can include compressing upper cell carrier onto batteries and lower cell carrier. The method 500 can comprise placing cells into inner cell carrier (e.g., bottom cell carrier). Cells can be lithium-ion cells. In an example, cells can include first terminal and second terminal. Terminal can be a terminal of cell, for example, first terminal can be positive terminal of cell and second terminal can be negative terminal of cell. Placement of each cell in the first and/or second inner cell carrier can be done using robots or other automated mechanisms. In an example, the direction of the cells (e.g., the orientation of first and/or second terminals) can be oriented away from another cell. In another example, orientation of the cells can be such that tabs are proximate housing. The method 500 can comprise placing outer cell carrier (e.g., top cell carrier or upper cell carrier) atop placed cells, outer cell carrier including a plurality of recesses configured to receive each cell.

At block 508, method 500 can include wire bonding cells to current collector. Wire bonding can include attaching a fusible link between first terminal and first conductive region of the current collector, thereby electrically connecting the cell to the current collector.

At block 510, method 500 can include attaching cold plate to a lower cell carrier.

At block 512, method 500 can include attaching telemetry module to the cold plate.

At block 514, method 500 can include attaching cell venting barrier to upper cell carrier. The cell venting barrier can have a clearance distance between 7 mm to 10 mm from the cell terminal.

At block 516, method 500 can include filling upper cell carrier with dispensed material. In an example, foam, liquid, or gel can be disposed around cells within casing to fill space between cells and between cells and interior surface of casing. This foam, liquid, or gel can provide insulation and can prevent propagation of thermal events between individual cells. Foam, liquid, or gel can also provide structural support by resisting vibration and aiding in mechanical retention of battery cells and components. Foam, liquid, or gel can provide thermal insulation, deflect and channel venting gasses, and adsorb radiant heat.

At block 518, method 500 can include assembling the modules into a battery pack. For example, one or more assemblies may be attached to case of enclosure. Additionally, BMS and connectors can also be attached or installed onto case of enclosure. Additionally, it will be understood that various connections can be made, for example, cold plates can be plumbed such that coolant fluid can pass into and out of the cold plate channels. Various other electrical and mechanical connections can be made. Lid can be installed onto case.

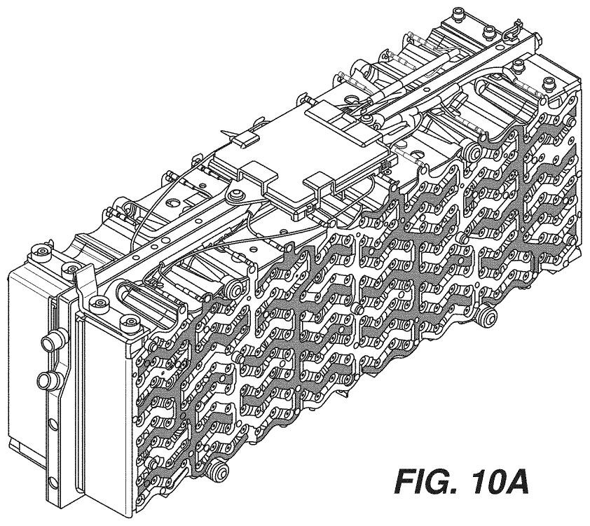

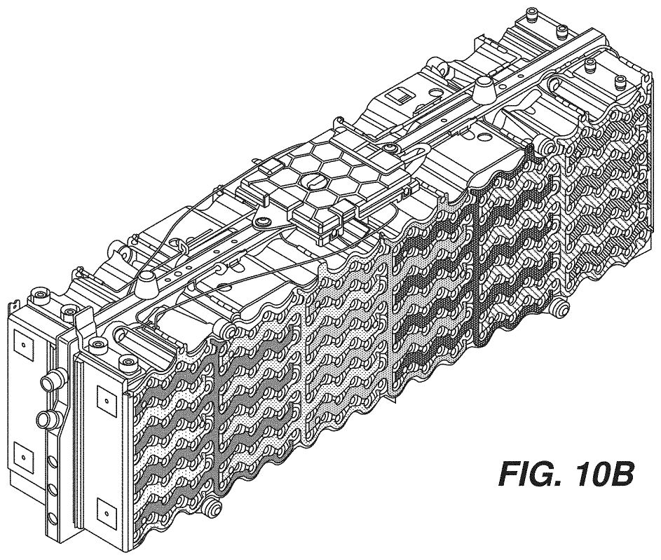

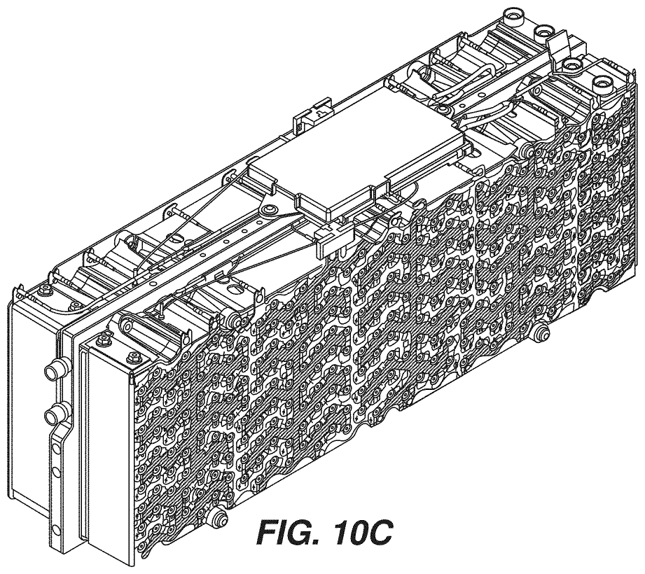

FIGS. 10A to 10C are isometric schematic views of example assemblies having different current collector patterns, as described previously.

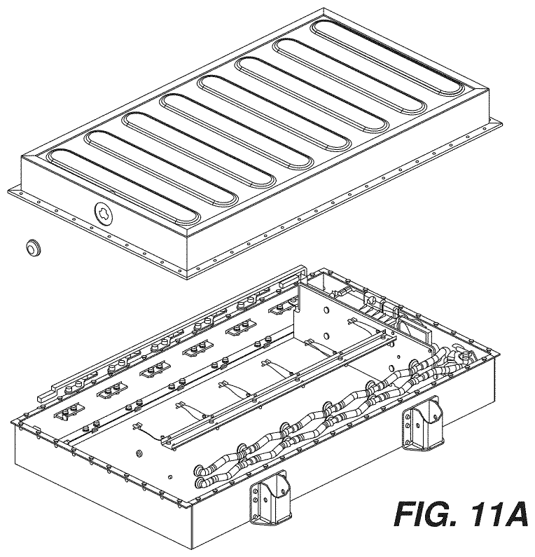

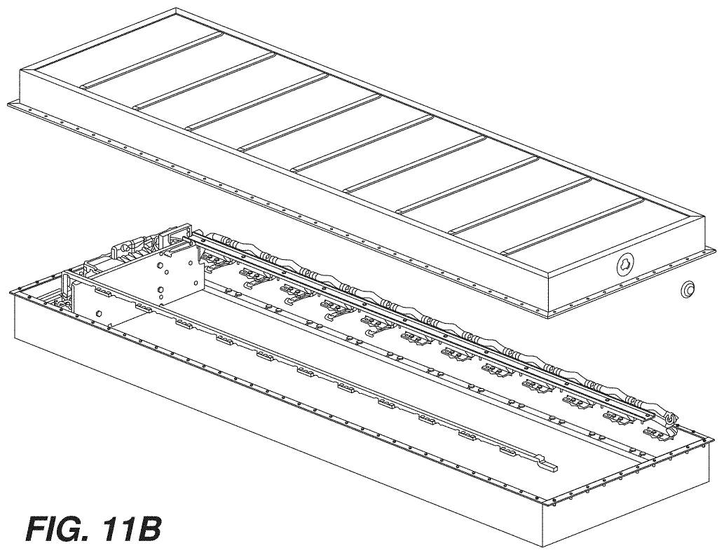

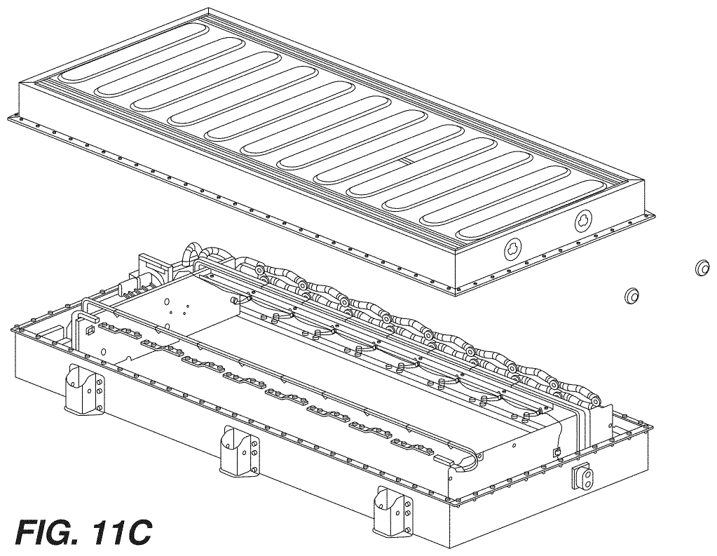

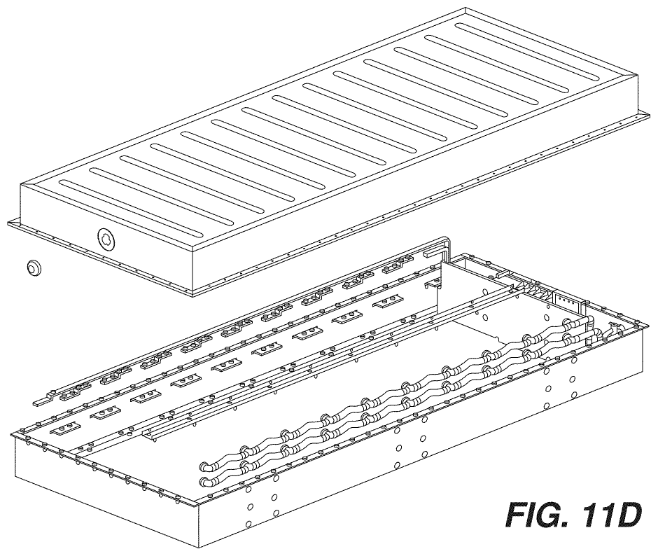

FIGS. 11A to 11D are isometric exploded views of enclosures without assemblies installed therein. FIGS. 11A to 11D depict modular enclosures having varying dimensions and configured to contain one or more assemblies 300a, 300b and/or BMS 200. FIGS. 11A to 11D also illustrate various stiffening patterns that can be integrally formed on the lid.

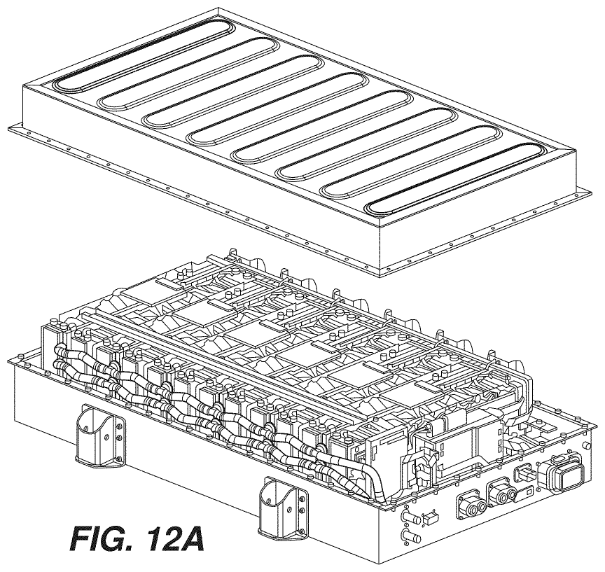

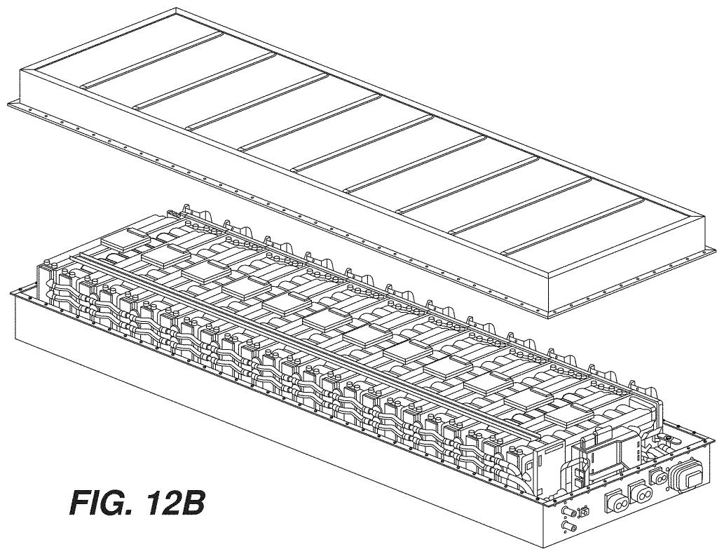

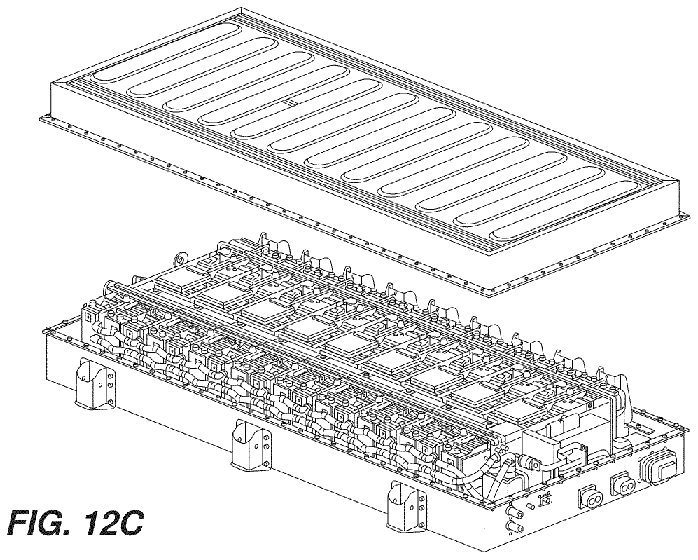

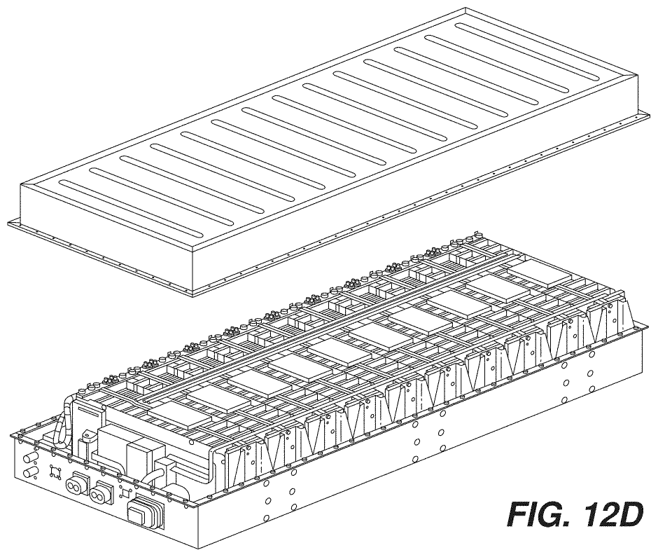

FIGS. 12A to 12D are isometric exploded view of example embodiment batteries having varying dimensions of the enclosure and with assemblies and/or BMS installed.

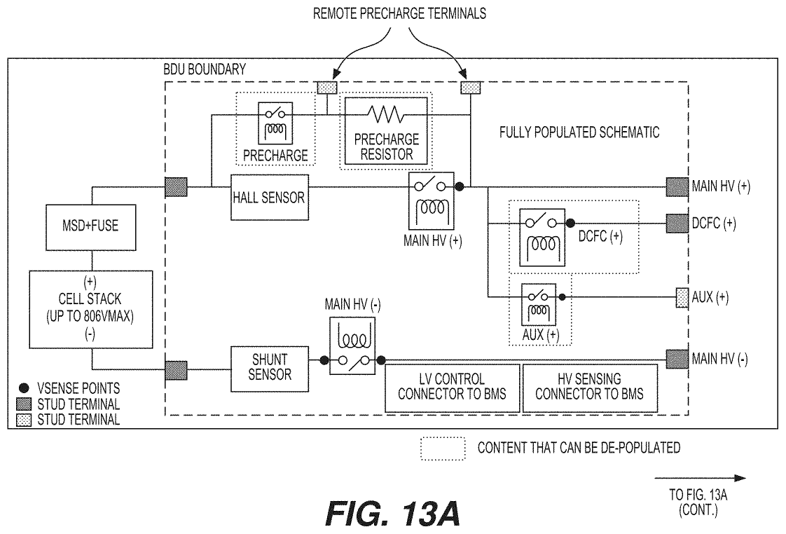

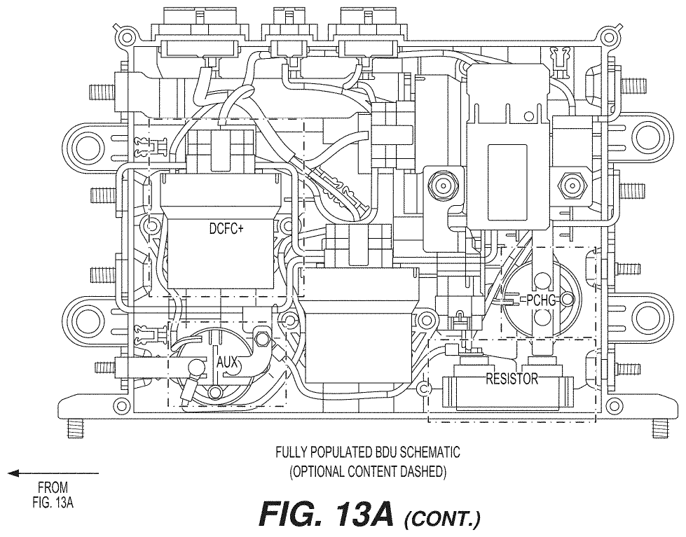

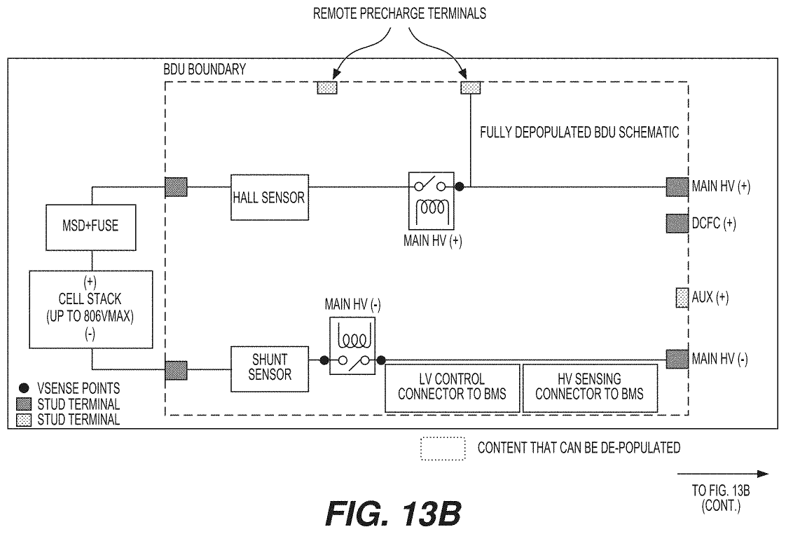

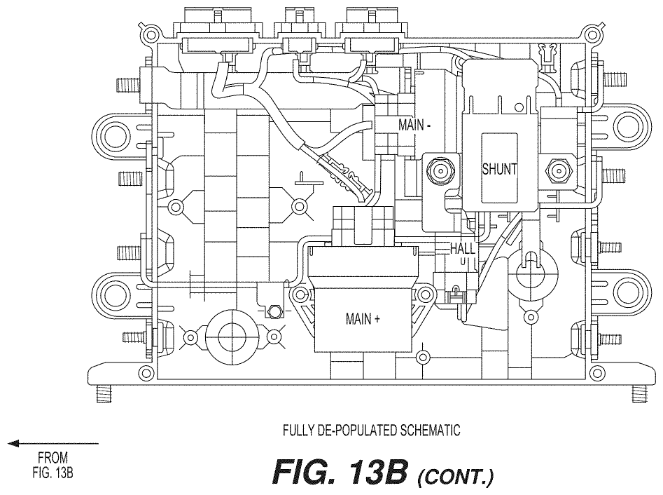

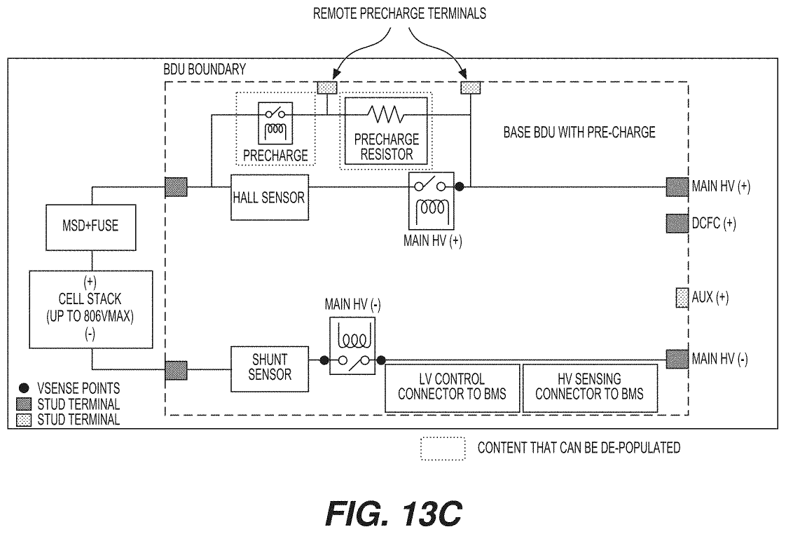

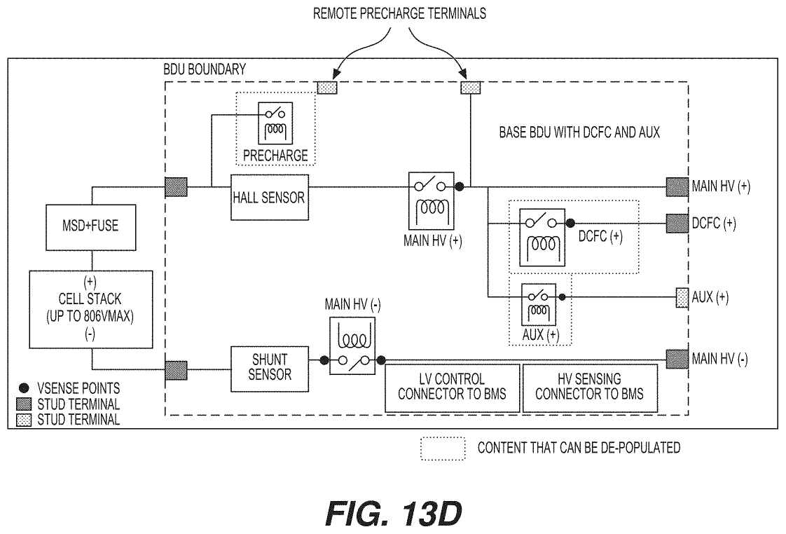

FIG. 13A is an electrical schematic of an example fully populated BDU configuration, according to an embodiment of the present disclosure.

FIGS. 13B-C are example depopulated BMS configurations, according to an embodiment of the present disclosure.

### Example 1

Cells and temperature sensors were placed into at least one cell carrier to form a subassembly. Two such subassemblies were prepared and connected by one intermodule busbar between like polarities. Thirty cells were electrically connected to current collector in parallel to form a cell group, and eight cell groups of 30-cells each were also electrically connected to current collector in series to form each subassembly. Foam was then injected through accessible hole in subassembly. Two electrically-connected, foamed subassemblies were disposed with a heat sink disposed between inside faces of the two subassemblies. If an electrically conductive heat sink is used, electrically insulating, thermally conductive interface material is placed on exposed surfaces of the cells on two open faces of the subassemblies. Subassemblies are then brought together and fastened to heat sink, capturing heat sink in predetermined position between the two subassemblies. A cell venting barrier was attached to at least one subassembly over the current collector. Telemetry module was then attached to the heat sink. Telemetry module was electrically connected to voltage sensors and temperature sensors. Electrical check was performed on each subassembly to determine efficacy and operability of electrical connections and components. Safety check was performed on each subassembly to verify the integrity of electrical isolation between components.

Six such assemblies, a BMS, and a Battery Disconnect Unit (BDU) were then placed in case. BMS and BDU were installed in first compartment of case, and assemblies installed in second compartment of case. BDU is electrically connected to the BMS. BMS was electrically connected to electrical connection points on each telemetry modules. BDU was electrically connected to electrical interface installed on case. BDU is electrically connected to each of the six assemblies using intramodule busbars. Another intermodule busbar is connected between like polarities of each subassembly of each assembly, thereby completing the electrical circuit between the six assemblies, BDU, and BMS.

Electrical check was performed to determine efficacy and operability of electrical components. Safety check was performed on each subassembly to verify the integrity of electrical isolation between components. A leak check was conducted to verify integrity of coolant and heat sink assembly. Lid is then installed and fastened over the case containing the assemblies, BDU, and BMS.

The resulting battery has 352V nominal voltage and 149 Ah nominal capacity.

### Example 2

Cells and temperature sensors were placed into at least one cell carrier to form a subassembly. Two such subassemblies were prepared and connected by one intermodule busbar between like polarities. Sixty cells were electrically connected to current collector in parallel to form a cell group, and four cell groups of 60-cells each were electrically connected to current collector in series to form each subassembly. Foam was then injected through accessible hole in subassembly. Two electrically-connected, foamed subassemblies were disposed with a heat sink disposed between inside faces of the two subassemblies. If an electrically conductive heat sink is used, electrically insulating, thermally conductive interface material is placed on exposed surfaces of the cells on two open faces of the subassemblies. Subassemblies are then brought together and fastened to heat sink, capturing heat sink in predetermined position between the two subassemblies. A cell venting barrier was attached to at least one subassembly over the current collector. Telemetry module was then attached to the heat sink. Telemetry module was electrically connected to voltage sensors and temperature sensors. Electrical check was performed on each subassembly to determine efficacy and operability of electrical connections and components. Safety check was performed on each subassembly to verify the integrity of electrical isolation between components.

Twelve such assemblies, a BMS, and a Battery disconnect unit (BDU) were then placed in case. BMS and BDU were installed in first compartment of case, and assemblies installed in second compartment of case. BDU is electrically connected to the BMS. BMS was electrically connected to electrical connection points on each telemetry modules. BDU was electrically connected to electrical interface installed on case. BDU is electrically connected to each of the twelve assemblies using intramodule busbars. Another intermodule busbar is connected between like polarities of each subassembly of each assembly, thereby completing the electrical circuit between the twelve assemblies, BDU, and BMS.

Electrical check was performed to determine efficacy and operability of electrical components. Safety check was performed on each subassembly to verify the integrity of electrical isolation between components. A leak check was conducted to verify integrity of coolant and heat sink assembly. Lid is then installed and fastened over the case containing the assemblies, BDU, and BMS.

The resulting battery has a 352V nominal voltage and 299 Ah nominal capacity.

### Example 3

Cells and temperature sensors were placed into at least one cell carrier to form a subassembly. Two such subassemblies were prepared and connected by one intermodule busbar between like polarities. Forty-eight cells were electrically connected to current collector in parallel to form a cell group, and six cell groups of 48-cells each were electrically connected to current collector in series to form each subassembly. Foam was then injected through accessible hole in subassembly. Two electrically-connected, foamed subassemblies were disposed with a heat sink disposed between inside faces of the two subassemblies. If an electrically conductive heat sink is used, electrically insulating, thermally conductive interface material is placed on exposed surfaces of the cells on two open faces of the subassemblies. Subassemblies are then brought together and fastened to heat sink, capturing heat sink in predetermined position between the two subassemblies. A cell venting barrier was attached to at least one subassembly over the current collector. Telemetry module was then attached to the heat sink. Telemetry module was electrically connected to voltage sensors and temperature sensors. Electrical check was performed on each subassembly to determine efficacy and operability of electrical connections and components. Safety check was performed on each subassembly to verify the integrity of electrical isolation between components.

Nine such assemblies, a BMS, and a Battery disconnect unit (BDU) were then placed in case. BMS and BDU were installed in first compartment of case, and assemblies installed in second compartment of case. BDU is electrically connected to the BMS. BMS was electrically connected to electrical connection points on each telemetry modules. BDU was electrically connected to electrical interface installed on case. BDU is electrically connected to each of the nine assemblies using intramodule busbars. Another intermodule busbar is connected between like polarities of each subassembly of each assembly, thereby completing the electrical circuit between the nine assemblies, BDU, and BMS.

Electrical check was performed to determine efficacy and operability of electrical components. Safety check was performed on each subassembly to verify the integrity of electrical isolation between components. A leak check was conducted to verify integrity of coolant and heat sink assembly. Lid is then installed and fastened over the case containing the assemblies, BDU, and BMS.

The resulting battery has a 396V nominal voltage and 239 Ah nominal capacity.

### Example 4

Cells and temperature sensors were placed into at least one cell carrier to form a subassembly. Two such subassemblies were prepared and connected by one intermodule busbar between like polarities. Thirty-four cells were electrically connected to current collector in parallel to form a cell group, and nine cell groups of 34-cells each were electrically connected to current collector in series to form each subassembly. Foam was then injected through accessible hole in subassembly. Two electrically-connected, foamed subassemblies were disposed with a heat sink disposed between inside faces of the two subassemblies. If an electrically conductive heat sink is used, electrically insulating, thermally conductive interface material is placed on exposed surfaces of the cells on two open faces of the subassemblies. Subassemblies are then brought together and fastened to heat sink, capturing heat sink in predetermined position between the two subassemblies. A cell venting barrier was attached to at least one subassembly over the current collector. Telemetry module was then attached to the heat sink. Telemetry module was electrically connected to voltage sensors and temperature sensors. Electrical check was performed on each subassembly to determine efficacy and operability of electrical connections and components. Safety check was performed on each subassembly to verify the integrity of electrical isolation between components.

Ten such assemblies, a BMS, and a Battery disconnect unit (BDU) were then placed in case. BMS and BDU were installed in first compartment of case, and assemblies installed in second compartment of case. BDU is electrically connected to the BMS. BMS was electrically connected to electrical connection points on each telemetry modules. BDU was electrically connected to electrical interface installed on case. BDU is electrically connected to each of the ten assemblies using intramodule busbars. Another intermodule busbar is connected between like polarities of each subassembly of each assembly, thereby completing the electrical circuit between the ten assemblies, BDU, and BMS.

Electrical check was performed to determine efficacy and operability of electrical components. Safety check was performed on each subassembly to verify the integrity of electrical isolation between components. A leak check was conducted to verify integrity of coolant and heat sink assembly. Lid is then installed and fastened over the case containing the assemblies, BDU, and BMS.

The resulting battery has a 661V nominal voltage and 169 Ah nominal capacity.

It will be understood that before inclusion within a battery module, battery cells can be inspected. Inspection can comprise human or automated verification that each cell is free from visual defects, structural damage, that each cell is within physical measurement specifications, that each cell meets material composition or chemical specifications, and that each cell is overall suitable for inclusion in a battery module. Battery cells can also be prepared for inclusion in a battery subassembly by desleeving or removing any temporary or excess housing or packaging.

The descriptions of the various embodiments of the present disclosure have been presented for purposes of illustration and are not intended to be exhaustive or limiting. Multiple modifications and variations of the disclosed embodiments will be apparent to those of ordinary skill in the art, without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain features of the present disclosure, which are, for clarity, described in the context of separate embodiments, may also be combined in a single embodiment. Conversely, various features of the invention, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

What is claimed is:

1. A battery module comprising:
a subassembly including:
cells electrically connected to form a group; and
groups of cells electrically connected to form the subassembly;
the subassembly comprising a lower cell carrier and an upper cell carrier configured to retain a thermally insulating material;
the group of cells disposed between the upper and lower cell carriers;
cell alignment and retention features integrally formed with one or more of:
lower or upper cell carriers;
means for inhibiting propagation of thermal runaway;
a current collector comprising two or more conductive regions; and
positive and negative terminals electrically connected to the two or more conductive regions, respectively to form positive and negative terminals of battery module.

2. The battery module of claim 1, wherein the means for inhibiting thermal runaway comprises one or more of: a dispensed material, cold plate, a barrier, coatings, or membranes.

3. The battery module of claim 1, wherein the means for inhibiting propagation of thermal runaway further comprises preventing propagation of thermal runaway between a first cell of the group of cells and a second cell in the same group of cells in the same module.

4. The battery module of claim 1, wherein the means for inhibiting propagation of thermal runaway further comprises preventing propagation of thermal runaway between a first cell in the group of cells and a second cell in an adjacent module.

5. The battery module of claim 1, wherein the group of cells is a first group of cells, the subassembly is a first subassembly, the current collector is a first current collector, the battery module further comprising:
a second subassembly including:
a second group of cells electrically connected to form a second subassembly;
the second subassembly including a lower cell carrier and an upper cell carrier between which the second group of cells are disposed, and having first and second faces; and
a second current collector electrically connecting the second subassembly.

6. The battery module of claim 1, further comprising adding capacity by increasing the number of cells in the subassembly.

7. The battery module of claim 1, further comprising reducing capacity by decreasing the number of cells in the subassembly.

8. The battery module of claim 1, comprising a module having first current collector and a module having a second current collector, wherein the module comprising the second current collector has a voltage different from the module comprising the first current collector.

9. The battery module of claim 8, wherein the module comprising the first current collector and the module comprising the second current collector are configured to use the same components other than the current collector.

10. A battery module of claim 1, comprising a module having first current collector and a module having a second current collector, wherein the module comprising the second current collector has a capacity different from the module comprising the first current collector.

11. The battery module of claim 10, wherein the module comprising the first current collector and the module comprising the second current collector are configured to use the same components other than the current collector.

12. The battery module of claim 1, comprising a module having first current collector and a module having a second current collector, wherein the module comprising the second current collector has a different voltage and the same energy as the module comprising the first current collector.

13. The battery module of claim 12, wherein the module comprising the first current collector and the module comprising the second current collector are configured to use the same components other than the current collector.

14. The battery module of claim 1, comprising a module having first current collector and a module having a second current collector, wherein the module comprising the second current collector has a different capacity and the same energy as the module comprising the first current collector.

15. The battery module of claim 14, wherein the module comprising the first current collector and the module comprising the second current collector are configured to use the same components other than the current collector.

16. The battery module of claim 1, wherein the current collector further comprises one or more layers, the layers comprising:
a conductive layer comprising a pattern defining a plurality of conductive regions; and
an isolation layer.

17. The battery module of claim 1, wherein the current collector further comprises one or more layers, the layers comprising:
a pressure sensitive adhesive layer;
a conductive layer comprising a pattern defining a plurality of conductive regions, and
an isolation layer.

18. The battery module of claim 1, further comprising a telemetry module in communication with one or more sensors associated with the subassembly, the one or more sensors configured to detect at least one of: a temperature or a voltage.

19. A battery comprising:
one or more battery modules, the quantity of modules determined by a desired voltage or amp-hour requirement;
an enclosure comprising a case and a lid;
an extruded aluminum profile forming the case; and
one or more aluminum enclosures formed from the extruded aluminum profile.

20. The battery of claim 19, comprising two or more extruded aluminum enclosures that vary in depth.

21. The battery of claim 19, comprising two or more extruded aluminum enclosures that vary in length.

22. The battery of claim 19, wherein the lid includes a stiffening pattern formed integrally thereon.

23. The battery of claim 19, further comprising:
a battery management system (BMS) including electrical components associated with BMS functionality, the BMS configured to communicate with one or more telemetry modules associated with one or more battery modules.

24. The battery of claim 23, wherein BMS functionality includes at least one of: fast charging, remote precharging, or an auxiliary input.

25. The battery of claim 23, wherein increasing a number of the electrical components is associated with additional BMS functionality.

26. The battery of claim 23, wherein decreasing a number of the electrical components is associated with limited BMS functionality.
